(19) United States
(12) Patent Application Publication
(10) Pub. No.: US 2012/0191840 A1
(43) Pub. Date: Jul. 26, 2012

(54) Managing Application State Information By Means Of A Uniform Resource Identifier (URI)

(76) Inventor: Vladislav Gordon, Stuttgart (DE)

(21) Appl. No.: 13/497,850

(22) PCT Filed: Jul. 9, 2010
(86) PCT No.: PCT/EP10/59869

§ 371 Date: Apr. 10, 2012

(30) Foreign Application Priority Data
Sep. 25, 2009 (EP) 09171317.2

(51) Int. Cl. G06F 15/173

(52) U.S. Cl. 709/223

(57) ABSTRACT

Providing application state information based on a Uniform Resource Identifier (URI) which identifies a resource in a computer network, including: receiving a string of characters representing the URI; extracting from the string of characters representing the URI, application state information; extracting from the application state information, one or more application state elements; and storing in computer memory the application state information represented by the one or more application state elements.

### 1. BACKGROUND OF THE INVENTION

1.1. Field of the Invention

The present invention relates to a computerized method for providing application state information based on a Uniform Resource Identifier (URI), a computerized method for providing a URI based on application state information, a computerized method for managing application state information by means of a URI, a computer data structure relating to application state information, a computer system for providing application state information based on a URI, a computer system for providing a URI based on application state information, a computer system for managing application state information by means of a URI, and a computer program product for managing application state information by means of a URI.

1.2. Description and Disadvantages of Prior Art

IBM® z/OS® Resource Measurement Facility (RMF) provides performance measurement and management. This product collects performance data for the operating system z/OS and mainframe environments to monitor the systems' performance. The z/OS RMF Distributed Data Server (DDS) provides a web frontend to the performance data, which can be displayed using a web browser. Each resource of the system to be monitored is associated with various metrics, which are measures of some property of a piece of software or hardware, for example, processor utilization. For details, see the product document pages at the following URLs: http://www-03.ibm.com/servers/eserver/zseries/zos/rmf/ and documents therein, for example, at ftp://ftp.software.ibm.com/eserver/zseries/zos/rmf/ the documents RMF_MonitorIII_DataPortal.pdf and RMFNewsletterl5.pdf.

In general, a web browser or web client can access a web server, such as the RMF DDS, over a network, such as the Internet (World Wide Web or WWW) or an intranet. To do this, a Uniform Resource Locator (URL) may specify where an identifiable resource is available in the computer network. By means of the URL, the web client can download information from the web server to view the downloaded contents as web pages and navigate between them using hyperlinks. A web application is an application program that is typically executed server-side by the web server. The downloaded contents may contain a part of the web application program code that is carried out client-side by the web client.

The following sections describe basics of the URL, the web applications, and scripting languages, for example, JavaScript: A Uniform Resource Identifier (URI) is a generalization of a URL, which is used to identify or name a resource in the Internet (WWW) or in an intranet. Such identification enables interactions with the resource over the network using protocols. The URI consists of a string of characters. The URI syntax essentially offers a URI scheme name terminated by a colon character and a hierarchical scheme-specific part. The URI scheme is also referred to as a protocol. Examples for the URI scheme name are “http:”, “ftp:”, etc. The hierarchical part usually begins with a double forward slash (“//”), followed by an authority part and an optional path. The parts of a URI are explained by way of the following example: “http://user:password@example.com:8037/over/there/index.dtb?name=ferret#nose. The authority part holds an optional user information part (“user:password”) terminated with “@”, a hostname (“example.com”), that is, a domain name or an IP address, and an optional port number (“8037”) preceded by a colon (“:”). The path part (“/over/there/index.dtb”) is a sequence of segments separated by forward slashes (“/”). A query (“?name=ferret”) is an optional part separated with a question mark (“?”), which contains additional identification information, which is not hierarchical in nature. The query string syntax is not generically defined, but is commonly organized as a sequence of <key>=<value> pairs separated by a semicolon (“;”) or separated by an ampersand (“&”). A so-called fragment (“#nose”), which is also known as an anchor part, is an optional part and is separated from the front parts by a hash (“#”). The fragment holds additional identifying information, for example, a part of a HTML document identified by the remainder of the URI. How these parts of the URI are arranged and separated from one another is scheme-specific and may be different for another protocol. A URI may be classified as a Universal Resource Locator (“URL”) or a Universal Resource Name (“URN”). The URN defines an item's identity, while the URL provides a method for finding its location. A so-called URI reference may take the form of a full URI, or just one or more trailing components of the scheme-specific part. URI references are frequently used in web-document markup languages. For details, see the link http://en.wikipedia.org/wiki under/Uniform_Resource_Identifier and /URI_scheme, and the link http://tools.ietf.org/html/rfc3986.

Client-side scripts, which may use the JavaScript scripting language, are often embedded within an HTML document. But they may also be contained in a separate file, which is referenced by the document. Upon request, the necessary file is sent to a user's computer by the web server on which they reside. The web browser executes the script, then displays the document, including any visible output from the script. Client-side scripts may also contain instructions for the web browser to follow if the user interacts with the document in a certain way, e.g., clicks a certain button or enters specific text. These instructions do not necessarily require further communication with the server. The JavaScript scripting language is characterized as a dynamic programming language with first-class functions because it treats functions as first-class objects. A programming language is said to be dynamic if it executes at runtime many common behaviors that other programming languages might perform during compilation. These behaviors could include extension of the program, by adding new code, by extending objects and definitions, or by modifying the type system, all during program execution. A first-class object is an entity which has an intrinsic identity. This implies, in particular, being constructible at runtime and being storable in variables. The JavaScript scripting language may support the Document Object Model (DOM), which is a cross-platform and language-independent convention for representing and interacting with objects in HTML and XML documents. For details, see the link http://en.wikipedia.org/wiki/ under /JavaScript, /Dynamic_programming_language, /First-class_function, /First-class_object, /Scripting_language, and /Client-side_scripting, and the links http://java.sun.com and http://www.w3.org/DOM.

JavaScript Object Notation (JSON) is a lightweight, text-based, language-independent computer data interchange format, which is used for the serialization of structured data, which may be transmitted over a network. JSON's design goals were for it to be minimal, portable, textual, and a subset of JavaScript. JSON can represent four primitive data types (Strings, Numbers, Booleans, and null) and two structured data types (Objects and Arrays). A string is a sequence of zero or more Unicode characters. An array, which is also called a vector or a list, is an ordered sequence of zero or more values. An object, which is also known as associative array or map in the literature, is an unordered collection of zero or more name-value pairs, which are also called key-value pairs, where a name is a string and a value is a string, number, boolean, null, another object, or an array. Code for parsing and generating JSON data is readily available for a large variety of programming languages.

JSON's main application is in AJAX (“Asynchronous JavaScript and XML”) web application programming, where JSON serves as an alternative to the use of the XML format. AJAX is a group of interrelated web development techniques used on the client-side to create interactive web applications or rich Internet applications. With AJAX, web applications can retrieve data from the web server asynchronously in the background without interfering with the display and behavior of the existing web page. Details may be available at the link http://en.wikipedia.org/wiki under /Associative_array, /JavaScript, /JSON, and /Ajax_(programming), and at the link http://tools.ietf.org/html/rfc4627.

Every non-trivial application program must manage its operating state, which is also called application state. This application state reflects actions, which the application program has performed and possibly committed, and further activities to be executed. In general, the application state can be described by a set of variables, which are stored and retrieved at a later time. Web applications use a couple of techniques to store their application states, which can be categorized as server-side and client-side. Often both types are used. Server-side storing is used for web applications when security is relevant. For example, an online banking application stores committed transactions in the web server. The web server generates a cookie, which is also known as a browser cookie or HTTP cookie, to store a small piece of text on a user's computer by the web browser. In detail, a cookie consists of one or more name-value pairs containing pieces of information, such as user preferences, information used within a server-based session, or other data used by websites. This unique cookie string identifies the state of the web application, which is stored on the web server. At every HTTP request, the web browser sends the cookie to the web server. The server can associate the cookie with the client state of the web application and usually sends back a HTTP response, which may contain an update of the cookie.

In many web applications, however, security only plays a minor role. In this case, it is convenient to store the state of the web application in a URL in the web browser. The web client sends the URL to the web server to retrieve information. For example, in the URL “http://myshop.com/search?category=cars&color=red&maxage=4” search criteria are stored in a query string to find a car with red color that is not older than four years. An application user can store this URL string in the web client, copy it to another web client, or send it to another application user, to access the resource with the same query information at a later time.

If a database query is very complex, the query string in the URL may become very long and hard to read or modify. Whenever a web application or a user changes the query string, a HTTP request must be sent to the web server to reflect the changed URL in the web client. The web server retrieves the requested information and returns a HTTP response. This may cost extra data processing resources and time.

US patent application 2009/0015599 teaches a draggable mechanism for identifying and communicating the state of an application. Metadata identifying application state information is represented in the fragment part of a URL by a sequence of <key>=<value> pairs separated by an ampersand (“&”). The metadata is updated at a predetermined interval to reflect new application states.

1.3. Objectives of the Invention

It is thus an objective of embodiments of the present invention to provide methods, computer data structures, and computer systems, which have a representation of even complex application states that is easy to maintain and exchange across a network.

### 2. SUMMARY AND ADVANTAGES OF THE INVENTION

According to a first aspect of the present invention, there is provided a computerized method for providing application state information based on a Uniform Resource Identifier (URI), which identifies a resource in a computer network. A string of characters representing the URI is provided. The string is parsed resulting in a substring representing the application state information by means of an independent data array. The independent data array is parsed resulting in elements of the independent data array. One of the resulted elements is identified as a dependent data array. The dependent data array is parsed resulting in elements of the dependent data array. The application state information represented by elements of the data arrays is provided.

Preferably, in a recursion, further ones of the resulted elements of the data arrays are identified as further dependent data arrays. Further dependent data arrays are parsed resulting in elements of the further dependent data arrays. From one of the elements, program code portions are retrieved to be executed by an application. The program code portions are associated with a function and are executed by invoking the function. The elements of each of the data arrays comprise one of the following: ordered values and pairs of keys and values. The keys are strings of characters and the values are one of the following: strings of characters, numbers, Boolean terms, and null values. Special characters separate following parts of the string representing the URI: the substring representing the application state information, the data arrays, the keys, and the values. A fragment part of the URI comprises the substring representing the application state information. A representation of the application state information uses a JavaScript Object Notation (JSON). The URI is a Uniform Resource Locator (URL).

According to a second aspect of the present invention, there is provided a computerized method for providing a Uniform Resource Identifier (URI), which identifies a resource in a computer network, based on application state information. The application state information is provided. Based on the application state information, a plurality of nested data arrays is constructed, which has one independent data array and one or more dependent data arrays, by inserting in a recursion the dependent data arrays as elements of other data arrays of the plurality of nested data arrays. A substring of characters representing the application state information by means of the plurality of nested data arrays is generated. A string of characters representing the URI is generated by inserting the generated substring. The URI is provided.

Preferably, at one of the elements, program code portions are stored to be executed by an application. The program code portions are associated with a function.

According to a third aspect of the present invention, there is provided a computerized method for managing application state information by means of a Uniform Resource Identifier (URI), which identifies a resource in a computer network. Based on the URI, application state information is provided according to the first aspect. An application processes the application state information. Based on the application state information, a URI is provided according to the second aspect.

According to a forth aspect of the present invention, there is provided a computer data structure relating to application state information. The data structure comprises a Uniform Resource Identifier (URI), which identifies a resource in a computer network. The URI is represented by a string of characters, which has a substring representing the application state information of an application by means of a plurality of nested data arrays, which has one independent data array and one or more dependent data arrays. Each of the dependent data arrays is an element of another data array of the plurality of nested data arrays.

Preferably, one of the elements comprises program code portions to be executed by the application. The program code portions are associated with a function.

According to a fifth aspect of the present invention, there is provided a computer system for providing application state information based on a Uniform Resource Identifier (URI), which identifies a resource in a computer network. A URI manager provides a string of characters representing the URI. A URI parser parses the string resulting in a substring representing the application state information by means of an independent data array, and parses the independent data array resulting in elements of the independent data array. The URI parser identifies one of the resulted elements as a dependent data array, parses the dependent data array resulting in elements of the dependent data array, and provides the application state information represented by elements of the data arrays.

According to a sixth aspect of the present invention, there is provided a computer system for providing a Uniform Resource Identifier (URI), which identifies a resource in a computer network, based on application state information. An application provides the application state information. Based on the application state information, a URI generator constructs a plurality of nested data arrays, which has one independent data array and one or more dependent data arrays, by inserting in a recursion the dependent data arrays as elements of other data arrays of the plurality of nested data arrays, generates a substring of characters representing the application state information by means of the plurality of nested data arrays, generates a string of characters representing the URI by inserting the generated substring, and provides the URI.

According to a seventh aspect of the present invention, there is provided a computer system for managing application state information by means of a Uniform Resource Identifier (URI), which identifies a resource in a computer network. Based on a string of characters representing the URI, a URI parser provides application state information according to the fifth aspect. An application processes the application state information. Based on the application state information, a URI generator provides a URI according to the sixth aspect.

According to an eighth aspect of an embodiment of the present invention, there is provided a computer program product for managing application state information by means of a Uniform Resource Identifier (URI), which identifies a resource in a computer network. The computer program product comprises a computer usable medium and has computer usable program code embodied therewith. The computer usable program code is configured to perform the steps of the method according to aspects of the embodiment of the present invention. A string of characters representing the URI is provided. The string is parsed resulting in a substring representing the application state information by means of an independent data array. The independent data array is parsed resulting in elements of the independent data array. One of the resulted elements is identified as a dependent data array. The dependent data array is parsed resulting in elements of the dependent data array. The application state information represented by elements of the data arrays is provided.

Additional features and advantages are realized through the techniques of the present invention. Other embodiments and aspects of the present invention are described in detail herein and are considered a part of the present invention. For a better understanding of the present invention with advantages and features, refer to the description and to the drawings.

### 3. BRIEF DESCRIPTION OF THE DRAWINGS

The subject matter which is regarded as the present invention is particularly pointed out and distinctly claimed in the claims at the conclusion of the specification. The foregoing and other objects, features, and advantages of the present invention are apparent from the following detailed description taken in conjunction with the accompanying drawings, in which:

FIGS. 1a-c illustrate flow charts of a method for providing application state information according to an embodiment of the present invention.

FIGS. 2a-b illustrate flow charts of a method for providing a Uniform Resource Identifier according to an embodiment of the present invention.

FIG. 3 illustrates a flow chart of a method for managing application state information according to an embodiment of the present invention.

FIG. 4 illustrates a block diagram of a system for managing application state information according to an embodiment of the present invention.

FIG. 5 illustrates a flow chart of a method for managing application state information by a web application according to an embodiment of the present invention.

FIG. 6 illustrates an abstract block diagram of a data structure according to an embodiment of the present invention.

FIGS. 7a-c illustrate a formatted representation of application state information according to an embodiment of the present invention.

FIG. 8 illustrates a URL comprising application state information according to an embodiment of the present invention.

FIG. 9 illustrates JavaScript code to create an object representation of application state information according to an embodiment of the present invention.

FIG. 10a-b illustrate JavaScript code to parse and generate a URI representation of application state information according to an embodiment of the present invention.

### 4. DETAILED DESCRIPTION OF THE PREFERRED EMBODIMENT

A preferred embodiment of the present invention improves the technique of storing application state information in a URL string. Instead of storing the application state information in the query string of the URL, for example, “http://myshop.com/search?category=cars&color=red&maxage=4”, the preferred embodiment represents the same information in the fragment or anchor part of the URL, for example, “http://myshop.com/search#{category: “cars”, color: “red”, maxage: “4”}”. Invertedly, the stored application state information can also be retrieved from the URL.

In prior art, a query string is restricted to a flat array structure having a collection of key-value-pairs. The keys and values can only have primitive types, that is, strings, numbers and booleans. These values are not compound. According to the preferred embodiment, the application state information is serialized to JSON and stored in the URL. JSON allows to represent arbitrarily nested data structures and may support complex application state information.

In general, a string representation of a data array, which uses, for example, JSON, has following requirements to clearly identify the data array and its elements. A pre-defined pair of delimiters must mark begin and end of the data array, and thereby indicate, which elements belong together. Pre-defined separators between the elements show where elements begin and end in the string. Furthermore, pre-defined key or index separators may be used to clearly delimit key or indexes in the string of characters. In the case of JSON, these delimiters and separators are single special characters as described below.

In an AJAX web application, the substring of a URL before the fragment part, which is separated by the hash character (“#”), cannot be changed without reloading the whole page from the web server. Modifications of the fragment part, however, allow the client-side web application to locally update its application state without the need for the web client to communicate with the web server. This update of the application state does not necessarily imply a change of a visual representation of the page in the web browser.

The web browser or a client application may provide navigation elements to take a user back or forward to another page or to another location on a page. When a user clicks a configurable link, the web browser may go to a stored location. The browser history feature is a benefit of the preferred embodiment over AJAX applications, which do not store the application state in the URL.

The preferred embodiment provides an API for integrating a window application into a frame application. The frame application can launch the window application and specify parameters for its application state in the corresponding URL. The frame application can also easily modify the URL and define alternative launch targets.

To reproduce application scenarios, a user or technical support engineer can easily use a specific URL, which comprises the full information to restore a specific application state.

It is an objective of the preferred embodiment to be implemented in a specific environment, for example, IBM z/OS Resource Measurement Facility (RMF), where a web frontend may provide functions for customizing performance desktops (PerfDesks). A performance desktop is a web client view, which comprises multiple performance metrics (Metric). These metrics can be assigned to metric groups (MetricGroup). Each of the hierarchical components (PerfDesks, MetricGroup, Metric) may have separate customizable attributes. For example, a name can be specified to be displayed for each component. Metrics and/or metric groups can be added to or removed from the performance desktop. The metrics may comprise filter information, which specifies the amount of information to be retrieved from the web server. The web client application provides a user dialog for the customization of the performance desktops and dynamically reflects the customization changes in the data visualization of the web client and in a changed URL.

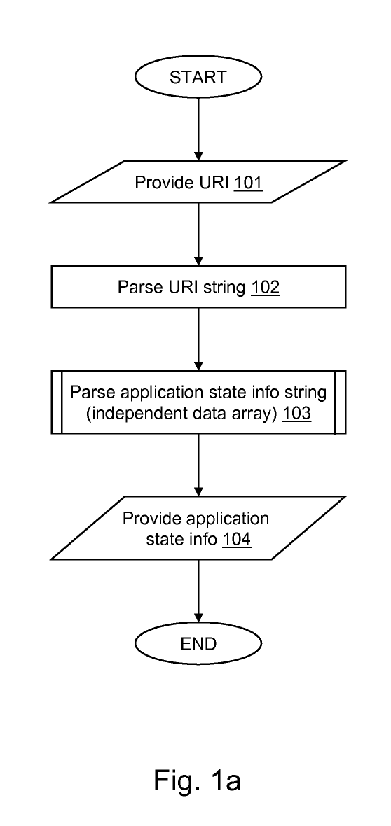

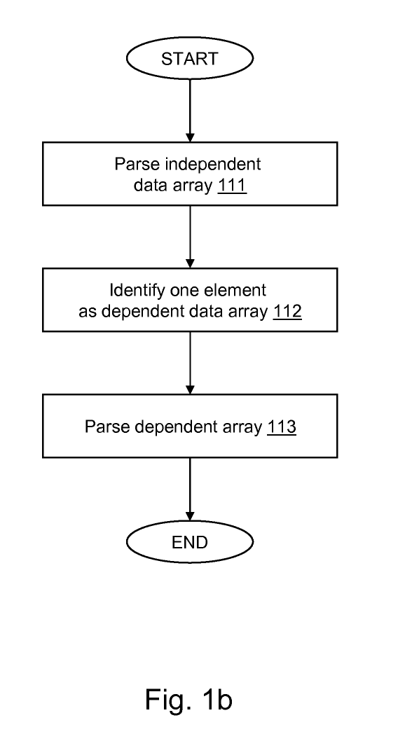

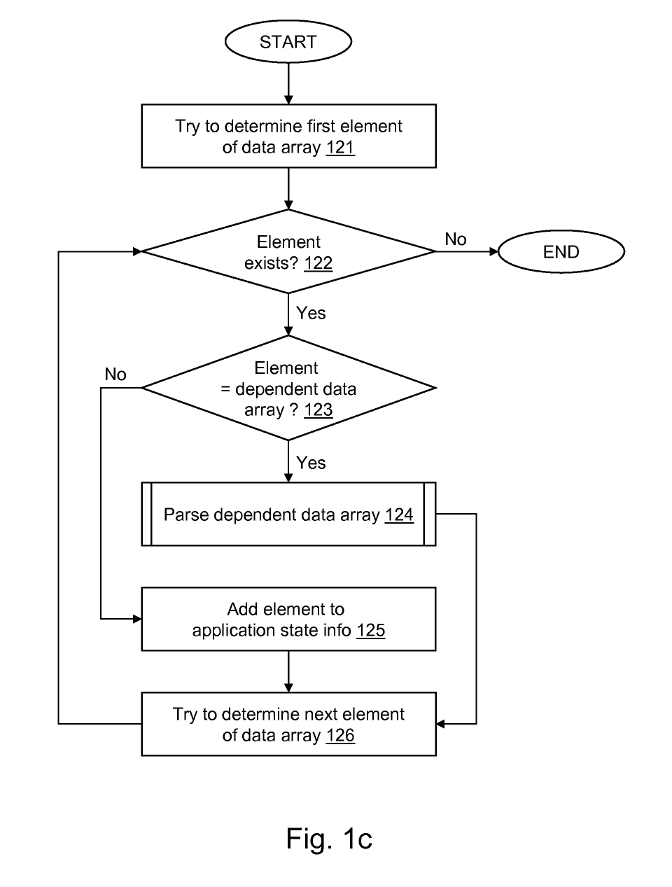

FIG. 1a-c illustrate flow charts of a method for providing application state information based on a Uniform Resource Identifier (URI). A URI manager, which may also be called a URI management component, provides a string of characters representing the URI in step 101. A URI parser parses the string in step 102, which results in a substring representing the application state information. The URI parser parses in step 103 this application state information substring, which represents an independent data array. This parsing results in elements of the independent data array. FIG. 1b illustrates sub-steps of the parsing step 103. While parsing the independent data array in step 111, the URI parser identifies one element as dependent data array in step 112, and parses this dependent data array in step 113, which results in elements of the dependent data array. Back in FIG. 1a, the URI parser provides in step 104 the application state information represented by the elements of the data arrays. FIG. 1c illustrates alternative sub-steps of the parsing step 103, which are applied to the independent data array and to the nested dependent data arrays. The URI parser parses the data arrays in a recursive procedure. The URI parser tries to determine a first element of the data array in step 121 and checks in step 122 if the element exists. If the result is “no”, the parsing procedure of FIG. 1c ends. If the result is “yes”, the URI parser tests in step 123 if the element is a dependent data array. In the positive case, the URI parser parses the dependent data array in step 124 by recursively performing the sub-steps of FIG. 1c. In the negative case, that is, when the element has a primitive data type, the URI parser adds the element to the application state information in step 125. After both steps 124 and 125, the URI parser tries to determine a next element of the data array in step 126 and operation returns to step 122, which checks if this element exists.

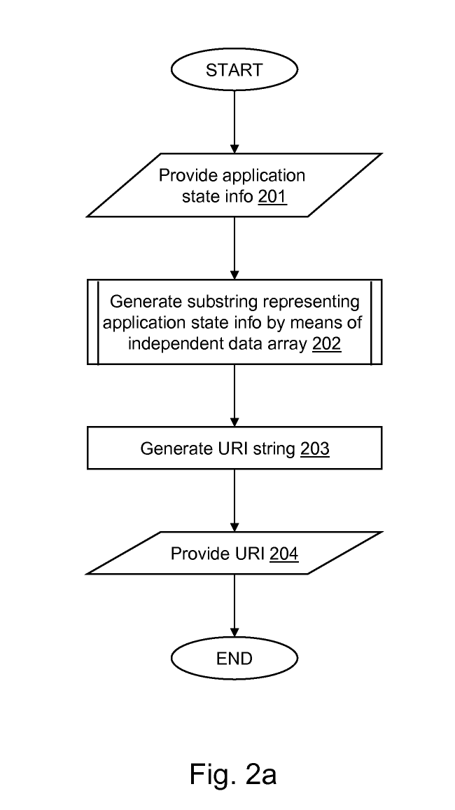

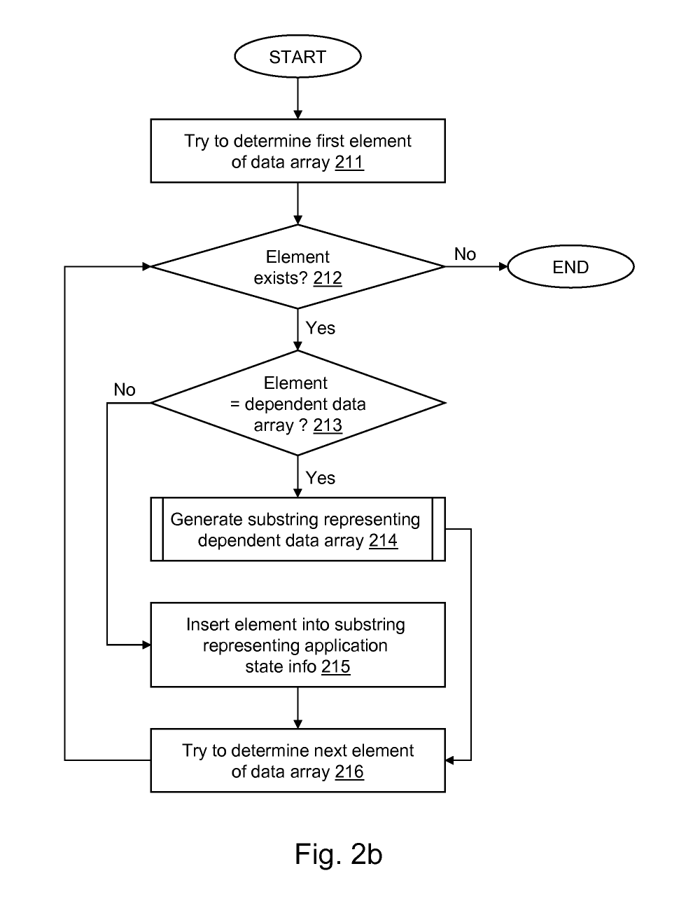

FIGS. 2a-b illustrate flow charts of a method for providing a URI based on application state information. In step 201, an application provides application state information. In step 202, a URI generator generates an application state information substring. The detailed sub-steps of step 202 are described in FIG. 2b. The URI generator begins a recursive procedure by constructing the substring representing an independent data array. In step 211, the URI generator tries to determine a first element of the data array based on the application state information and tests in step 212 if the element exists. If the result is “no”, the URI generator ends the procedure of FIG. 2b. If the result is “yes”, the URI generator checks in step 213 if the element represents a dependent data array. In the positive case, the URI generator constructs in step 214 a substring representing the dependent data array by recursively performing the sub-steps shown in FIG. 2b. In the negative case, the URI generator inserts the element into the application state information substring in step 215. After both steps 214 and 215, the URI generator tries to determine a next element of the data array based on the application state information in step 216 and operation returns to step 212, which checks if this element exists.

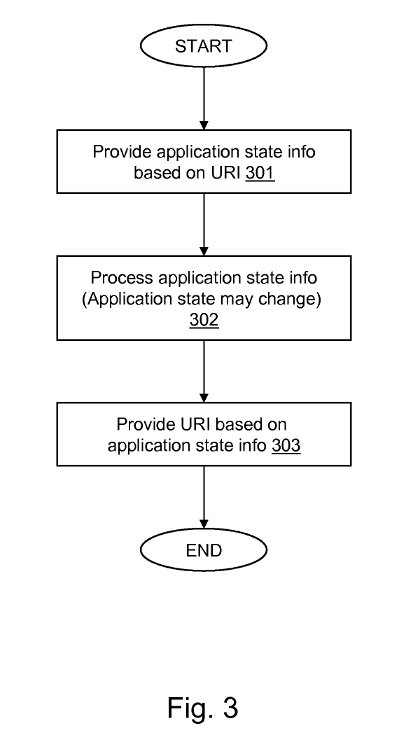

FIG. 3 illustrates a flow chart of a method for managing application state information by means of a URI: In step 301, a URI parser provides application state information based on the URI. In step 302, an application processes the application state information. The application state information may change. A URI generator provides the URI in step 303 based on the application state information.

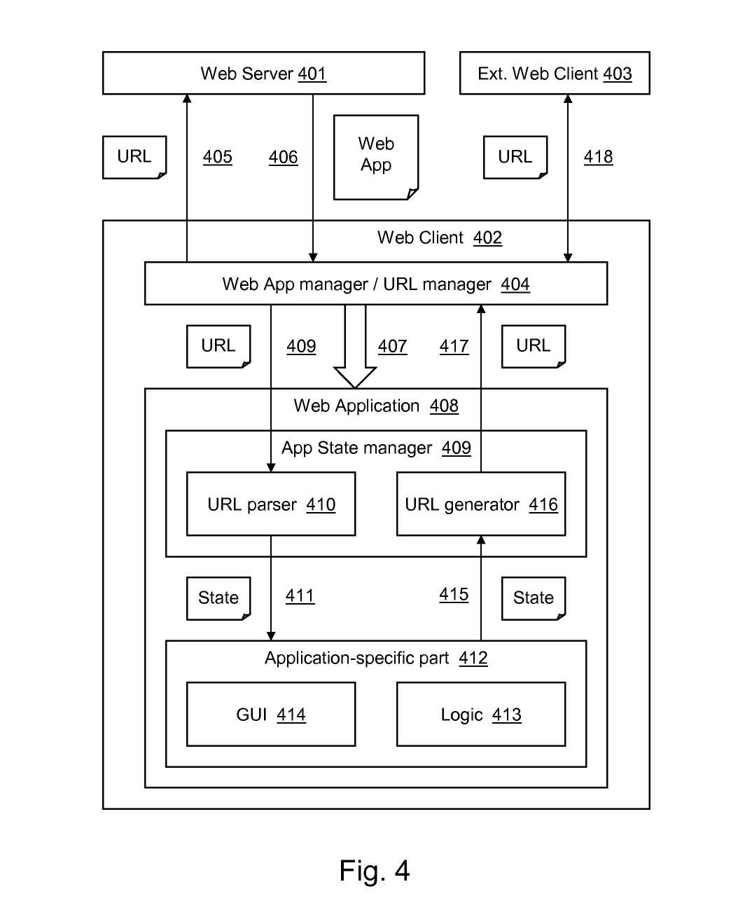

FIG. 4 illustrates a block diagram of a system for managing application state information. The system comprises a web server 401 and a web client 402, and possibly an external web client 403. The web client has a web application manager 404, which provides an interface between the web client and the web server. The web application manager controls the execution of the web application in the web client and manages a Uniform Resource Locator (URL), which identifies a resource located on the web server. The web client may provide an address field that displays the URL and allows to read and to change the URL by a user. The web application manager stores this URL, sends it in step 405 to the web server and receives web content in step 406, which contains scripts to be executed as a web application 408 by the web client. In step 407, the web application manager starts the web application. The web application comprises an application state manager 409, which has a URL parser 410 and a URL generator 416. When the web application starts, the URL manager 404, that is, the web application manager, provides a URL string in step 409. The URL parser converts the URL string into an application state object and provides it in step 411 for the application-specific part 412 of the web application. This application-specific part executes program logic 413 and exchanges information with a user by way of a graphical user interface 414. The application-specific part provides 415 an application state object, which usually reflects a changed application state. The URL generator converts the application state object into a URL string and provides it in step 417 to the URL manager, which stores the URL as a current state of the web application. This URL may be different from the previously stored URL. The user of the web client may read or modify this URL in the address field. In step 418, the URL can be used to start this web application with the stored application state by another web client 403 or vice versa. In step 405, the URL can also be re-sent to the web server 401 to re-load in step 406 the web application to the web client 402.

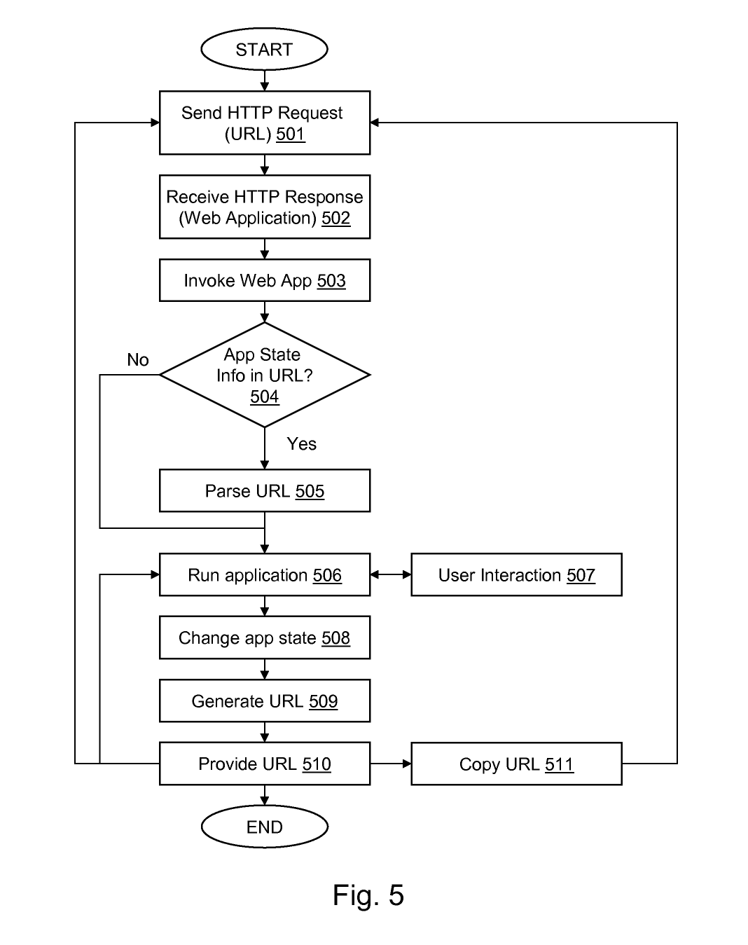

FIG. 5 illustrates a flow chart of a method for managing application state information by a web application. In step 501, the web client sends a HTTP request to a web server, which includes a URL to identify a resource on the web server. Then, in step 502, the web client receives a HTTP response, which may contain scripts to be executed as a client-side web application. The web client invokes the web application in step 503. The web application checks in step 504 if the URL comprises application state information. In the positive case, the web application parses the URL in step 505 to provide an application state object to the running application in step 506, which may perform user interactions in step 507. In the negative case, the web application skips the parsing step 505. The web application may change its application state in step 508, generate a changed URL in step 509 and provide the URL in step 510. Then, the application continues running in step 506. Returning to step 501, the provided URL can also be re-sent to the web server or copied in step 511 to be stored as a bookmark or to be used by another web client.

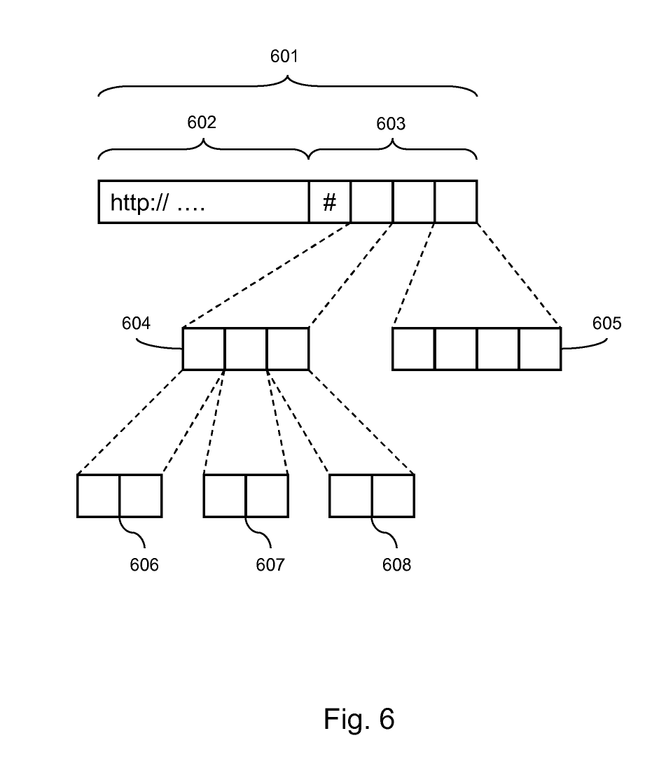

FIG. 6 illustrates an abstract block diagram of a URI string representing application state information. The URI string 601 comprises a first substring 602 having a URI scheme name and a hierarchical scheme-specific part and a second substring 603 representing application state information. When the second substring 603 starts with a hash (“#”) character, the second substring is called fragment or anchor part. The second substring 603 represents an independent data array. Some of its elements are dependent data arrays, 604 and 605, which may contain further dependent data arrays, 606, 607, and 608.

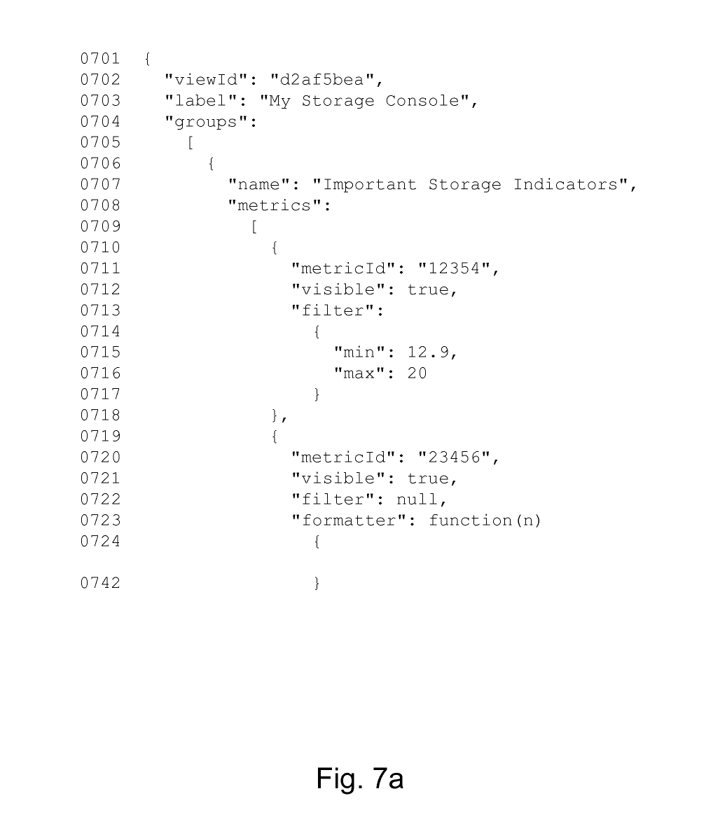

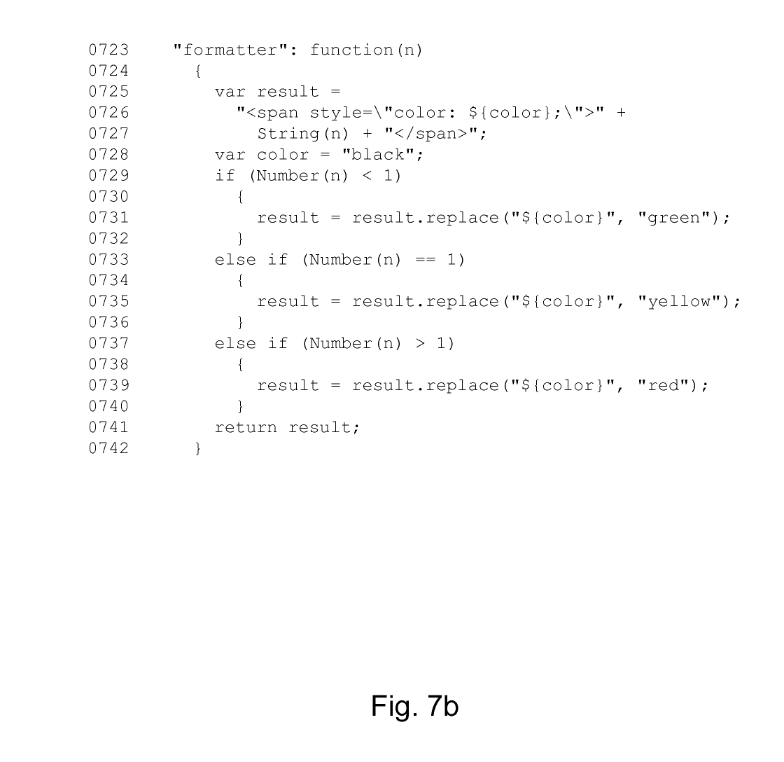

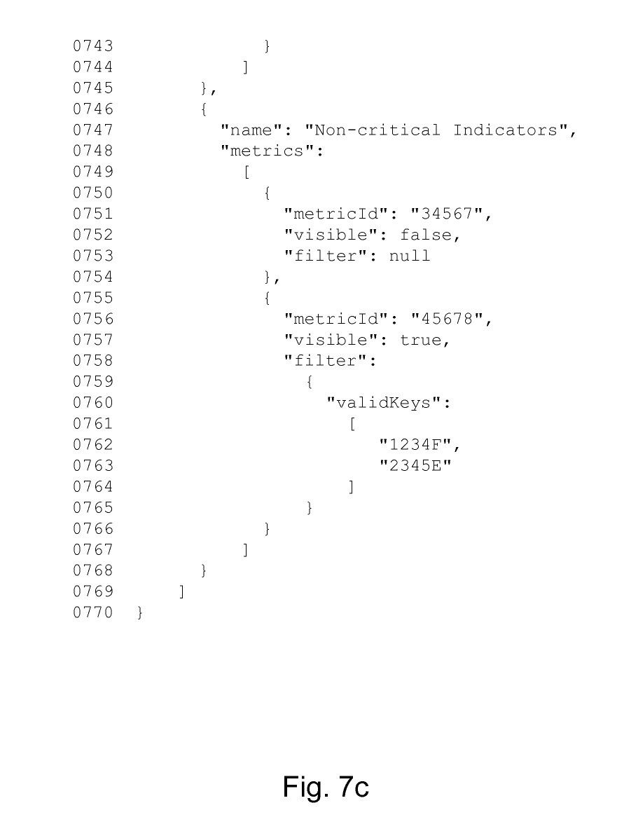

FIGS. 7a-c show in lines 701 to 770 a formatted representation of an application state object. The example is “My Storage Console”, which is a simplification of the RMF Performance Desktop. A specific storage console configuration has two group members: “Important Storage Indicators” and “Non-critical Indicators”. Each of the group members has metrics, which may specify a visible flag, a filter object, and an optional formatter function. The formatted representation comprises multiple data arrays, which are nested. JSON provides two structured basic data types for data arrays, which are called Array and Object. The Array is an ordered sequence of values, which are comma-separated and enclosed in square brackets. One example is the Array “groups” in lines 704 to 769 with two elements, which are identified by an integer index: “groups[0]” in lines 706 to 745, and “groups[1]” in lines 746 to 768. Both elements have a structured data type Object, which is described below. Another example is the Array “validKeys” in lines 760 to 764 with two elements, which have a primitive data type String. The Object is a collection of key-value-pairs or name-value pairs, which are comma-separated and enclosed in curly braces. FIGS. 7a-c show many such examples: The top-level independent data array in lines 701 to 770, which is called “state”, has multiple key-value pairs. The keys are of type String. The values are Strings for the keys “viewId” and “label” in lines 702 and 703 and an Array for the key “groups”. The value can be a Boolean term, that is, true or false, for example, in lines 721, 752, and 757. It can be a number, “12.9” and “20”, as shown in lines 715 and 716. A number may be an integer, decimal or floating point number. Or the value can be null, for example, in lines 722 and 753.

The metric with metricId=“23456” contains a key-value-pair in lines 723 to 742, where the key “formatter” points to a JavaScript function and the value is of type function and comprises program code portions. The function itself is anonymous. Only the pointer to the function is stored in a variable “formatter”. The function in this example formats an integer number “n”, which is provided as input. The output is a HTML string (“<span style=\”color: ${color};\“>”+String(n)+“</span>”), which contains the input number “n” and additional color information. If the number is less than 1, it is displayed with a green color. If the number is equal one, the value of the “color:” attribute is “yellow”. For numbers greater than 1, the number has a red color.

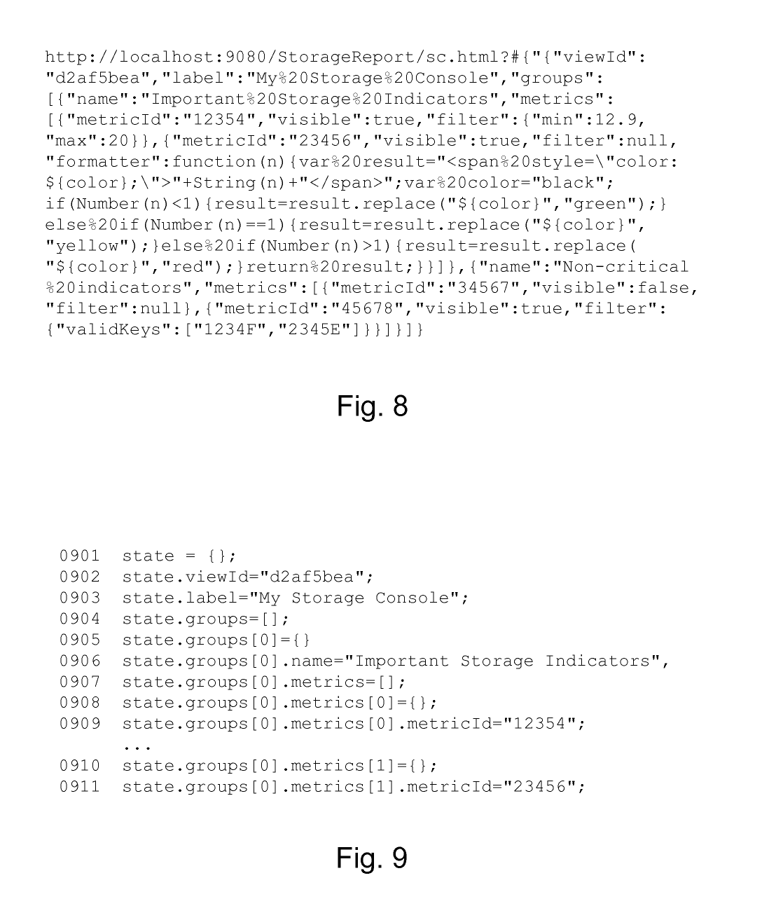

FIG. 8 illustrates a URL string comprising after the hash (“#”) character the substring representing the application state information that is shown in FIGS. 7a-c.

FIG. 9 illustrates some lines 901 to 911 of JavaScript code, which implements a part of a web application, to create an object representation of the application state information that is shown in FIGS. 7a-c. Each assignment (“=”) adds an element to a JavaScript object “state”. The identifiers of nested elements are separated by dots (“.”). Two empty curly braces (“{ }”) create an initial Object, that is, a data array containing key-value-pairs. Two empty square brackets (“[ ]”) create an initial Array, that is, a data array containing an ordered sequence of values. Values of the Object are assigned to respective keys. For example, in line 902, the value “d2af5bea” is assigned to the key “state.viewId”. When values are assigned to an Array, they are identified by an integer index. For example, in line 908, an initial Object (“{ }”) is assigned to the Array “state.groups[0].metrics” as a first value with index “[0]”, and in line 911, another initial Object (“{ }”) is assigned to the same Array as a second value with index “[1]”.

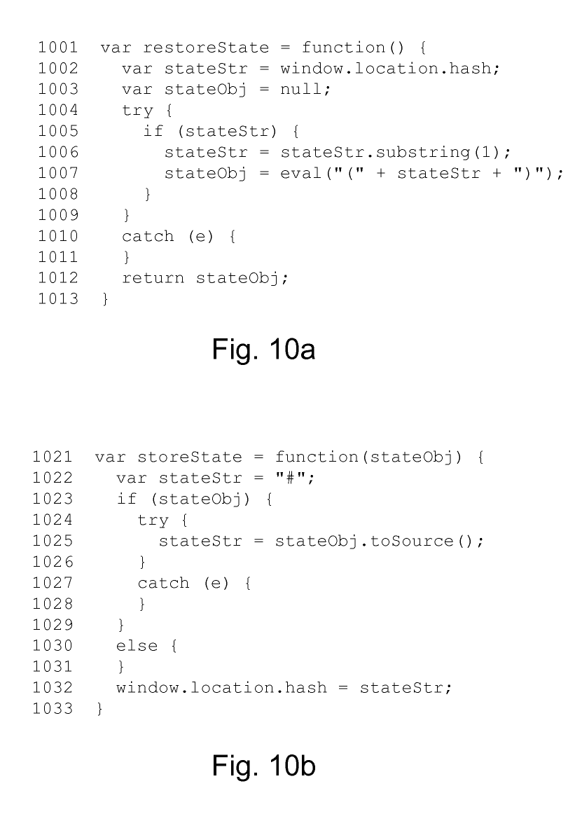

FIG. 10a illustrates JavaScript code, which implements a URL parser. The function “restoreState” parses a string representing an URL and provides a JavaScript object representing application state information. The function definition in line 1001 is called “restoreState” because the application state is restored based on the URL. The JavaScript object “window.location.hash” returns in line 1002 the fragment part of the URL and writes it to the String “stateStr”. An empty JavaScript object “stateObj” is created in line 1003. The following sub-function calls are surrounded by a try block in lines 1004 to 1009. The function “restoreState” tests in line 1005 if the String “stateStr” is not null and not empty. In the negative case, the JavaScript object “stateObj” remains unchanged, that is, null. In the positive case, the function “restoreState” in line 1006 removes the first character of the String “stateStr”, that is, the hash (“#”) separator. Then, a native JavaScript function “eval( )” is called in line 1007, which de-serializes the String “stateStr”, and writes the de-serialized information to the JavaScript object “stateObj”. The catch block in lines 1010 to 1011 contains no further exception handling. When an exception is thrown in line 1010, the JavaScript object “stateObj” remains null. The function “restoreState” returns in line 1012 the resulting JavaScript object “stateObj” when the evaluation step was successful. If the URL contains an invalid object, no object, or if an exception was thrown, the function returns null.

FIG. 10b illustrates JavaScript code implementing a URL generator. The function “storeState” generates and stores a String representing an URL based on a JavaScript object “stateObj” representing application state information. The function definition in line 1021 is called “storeState” because the application state information is stored. A String “stateStr” is created in line 1022 with one hash character (“#”) identifying the fragment part of the URL. The function “storeState” tests in line 1023 if the JavaScript object “stateObj” is not null and not empty. In the negative case, the String “stateStr” remains initial, that is, only contains the hash (“#”). In the positive case, the following sub-function calls are surrounded by a try block in lines 1024 to 1026. A native JavaScript function “toSource( )” is called in line 1025, which serializes the JavaScript object “stateObj” and appends the serialized information to the String “stateStr”. The catch block in lines 1027 to 1028 contains no further exception handling. When an exception is thrown in line 1027 because the JavaScript object “stateObj” is invalid, the String “stateStr” also remains initial. In line 1032, the resulting String “stateStr” is written to the JavaScript object “window.location.hash”, and thereby, the fragment part of the URL is set.

The serialization function “toSource( )” in line 1025 is not supported by some web browsers. Therefore, the preferred embodiment utilizes an Open Source implementation provided by Dojo toolkit. For details, see the link http://www.dojotoolkit.org/.

An alternative embodiment of the present invention may use a format other than JSON to serialize the application state information and a programming language other than JavaScript to execute the web application in the web browser. Extensible Markup Language (XML) can provide a representation of a plurality of nested data arrays, which has the same structure as the JSON representation. The characters which make up an XML document are divided into markup and content. All strings which constitute markup begin either with the character “<” and end with the next “>”, or begin with the character “&” and end with the character “;”. Strings of characters which are not markup are content. A tag is a markup construct that begins with “<” and ends with “>”. The XML based representation of the application state information is apparently much longer than JSON. For details, see the links http://en.wikipedia.org/wiki/XML and http://www.w3.org/XML/.

The alternative embodiment may use native Java to implement the URI parser and URI generator. Java methods may return a Java object “stateObj” when an input String “stateStr” is provided and vice versa. The implementation may use Application Programming Interfaces, which provide a parser that produces a Document Object model (DOM) object tree from the XML documents and access methods to elements of the object tree. The DOM object tree may be accessed by methods conforming to the org.w3c.dom.Document interface. Invertedly, an XML document may be generated based on a DOM object tree by calling appropriate methods.

Further alternative embodiments may use other scripting languages than JavaScript, which also allow to execute program code portions dynamically at runtime when associated with a variable. Examples are the scripting languages Python and Perl. In Python, the eval function evaluates a string as if it were a Python expression. The string can contain literals, simple expressions, or built-in functions. When Perl is given a file to execute or a string as a command line option, it needs to parse the contents, check it for syntax errors, and, if all is fine, execute it. Perl makes this feature available to the programmer through the eval command. For the compiler-based programming languages C/C++, there is no run-time evaluation of program code portions, but there are a number of public domain and commercial interpreters that can be linked in with a C application to support C or C++-like interpreted languages. Java, however, does not allow the production and evaluation of new code on the fly. A programmatic call of the Java compiler may provide a workaround. Details can be found at the following URLs: “http://effbot.org/zone/librarybook-core-eval.htm”, “http://docstore.mik.ua/orelly/perl/advprog/ch05_{—}01.htm”, and “http://docstore.mik.ua/orelly/perl/advprog/ch05_{—}01.htm”.

The execution of the web application is not restricted to the web client, but can also be performed in a web server. A URI, or more specifically, a URL or URN, which store application state information, may also be used internally in any kind of web-related application, that is, inside the web server or the web client. A URI can be exchanged between any communication partners in the web, for example, between two web servers and between two web clients.

The present invention is not limited to the example of performance monitors and administration consoles, but can be performed in any application areas where Information Technology resources need to be identified in a network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing has been with reference to particular embodiments of the invention, it will be appreciated by those skilled in the art that changes in these embodiments may be made without departing from the principles and spirit of the invention, the scope of which is defined by the appended claims.

1. A computerized method for providing application state information based on a Uniform Resource Identifier (URI) which identifies a resource in a computer network, the method comprising steps of:
receiving a string of characters representing URI;
extracting from the string of characters representing the URI, application state information;
extracting from the application state information, one or more application state elements; and
storing in computer memory the application state information represented by the one or more application state elements.

2. The method of claim 1, wherein one of the application states elements points to a function, the method further comprising:
retrieving from the application state element that points to the function, computer program instructions associated with the function; and
executing the computer program instructions associated with the function by invoking the function.

3. The method of claim 1, wherein each application state element includes a key-value pair, wherein the key is a string of characters and the values are a string of characters, numbers, Boolean terms, or null value.

4. The method of claim 1 wherein a fragment part of the URI includes the application state information.

5. The method of claim 1 wherein the application state information is formatted in accordance with JavaScript Object Notation (JSON).

6. The method of claim 1 wherein the URI is a Uniform Resource Locator (‘URL’).

7. A system for providing application state information based on a Uniform Resource Identifier (URI) which identifies a resource in a computer network, the system comprising a computer processor operatively coupled to computer memory, the computer memory including computer program instructions that, when executed by the computer processor, cause the computer to carry out the steps of:
receiving a string of characters representing the URI;
extracting from the string of characters representing the URI, application state information;
extracting from the application state information, one or more application state elements; and
storing in the computer memory the application state information represented by the one or more application state elements.

8. The system of claim 7, wherein one of the application states elements points to a function, the computer memory further comprising computer program instructions that, when executed by the computer processor, cause the computer to carry out the steps of:
retrieving from the application state element that points to the function, computer program instructions associated with the function; and
executing the computer program instructions associated with the function by invoking the function.

9. The system of claim 7, wherein each application state element includes a key-value pair, wherein the key is a string of characters and the values are a string of characters, numbers, Boolean terms, or null values.

10. The system of claim 7 wherein a fragment part of the URI includes the application state information.

11. The system of claim 7 wherein the application state information is formatted in accordance with JavaScript Object Notation (JSON).

12. The system of claim 7 wherein the URI is a Uniform Resource Locator (‘URL’).

13. A computer program product for providing application state information based on a Uniform Resource Identifier (URI) which identifies a resource in a computer network, the computer program product disposed in a computer readable medium, the computer program product including computer program instructions that, when executed by a computer, cause the computer to carry out the steps of:
receiving a string of characters representing the URI;
extracting from the string of characters representing the URI, application state information;
extracting from the application state information, one or more application state elements; and
storing in the computer memory the application state information represented by the one or more application state elements.

14. The computer program product of claim 13, wherein one of the application states elements points to a function, the computer program product further comprising computer program instructions that, when executed by the computer, cause the computer to carry out the steps of:
retrieving from the application state element that points to the function, computer program instructions associated with the function; and
executing the computer program instructions associated with the function by invoking the function.

15. The computer program product of claim 13, wherein each application state element includes a key-value pair, wherein the key is a string of characters and the values are a string of characters, numbers, Boolean terms, or null values.

16. The computer program product of claim 13 wherein a fragment part of the URI includes the application state information.

17. The computer program product of claim 13 wherein the application state information is formatted in accordance with JavaScript Object Notation (JSON).

18. The computer program product of claim 13 wherein the URI is a Uniform Resource Locator (‘URL’).

19. The computer program product of claim 13 wherein the computer readable medium comprises a signal medium.

20. The computer program product of claim 13 wherein the computer readable medium comprises a storage medium.
